(19) United States
(12) Patent Application Publication
(10) Pub. No.: US 2025/0224899 A1
(43) Pub. Date: Jul. 10, 2025

(54) STORAGE CONTROLLER AND STORAGE DEVICE INCLUDING THEREOF

(71) Applicant: SAMSUNG ELECTRONICS CO., LTD., Suwon-si (KR)

(72) Inventors: Sungup MOON, Suwon-si (KR); Walter JUN, Suwon-si (KR); Byung Yo LEE, Suwon-si (KR)

(73) Assignee: SAMSUNG ELECTRONICS CO., LTD., Suwon-si (KR)

(21) Appl. No.: 18/807,222

(22) Filed: Aug. 16, 2024

(30) Foreign Application Priority Data
Jan. 10, 2024 (KR) 10-2024-0004408

(51) Int. Cl. G06F 3/06

(52) U.S. Cl. CPC G06F 3/0655; G06F 3/061; G06F 3/0679

(57) ABSTRACT

A storage device configured to communicate with a first host, a second host, and a supervisor, includes: a nonvolatile memory device that may include a first namespace allocated for the first host, a second namespace allocated for the second host, and a plurality of address mapping tables; and a storage controller configured to, based on the plurality of address mapping tables: access the first namespace based on an input/output request from the first host; and access the second namespace based on an input/output request from the second host. The storage controller may include a first dedicated caching area partitioned to cache address mapping tables having a first table type corresponding to the first namespace among the plurality of address mapping tables.

### CROSS-REFERENCE TO RELATED APPLICATION

This application claims priority to Korean Patent Application No. 10-2024-0004408, filed on Jan. 10, 2024 in the Korean Intellectual Property Office, the disclosure of which is incorporated by reference herein in its entirety.

### BACKGROUND

### 1. Field

The present disclosure relates to a storage device. More particularly, the present disclosure relates to a storage controller supporting multi-host and a storage device including the same.

### 2. Description of Related Art

A flash memory-based storage device does not allow overwrite. Accordingly, a storage controller of the flash memory-based storage device may store address mapping tables that map logical address managed by a host and physical address managed by the storage device. However, if storage controller of hyper-large capacity storage device stores an address mapping table for all physical addresses, the address mapping tables may consume excessively large capacity. Accordingly, the hyper-large capacity storage device may store a plurality of address mapping tables in a nonvolatile memory device, and then may operate by caching some address mapping tables in the storage controller.

Recently, a multi-host storage system, in which a single storage device is configured to communicate with a plurality of hosts or a plurality of tenants, has been developed. In general, if the plurality of hosts accesses the single storage device, since resource of the single storage controller is limited, there may be a problem of performance deteriorating provided for each of the plurality of hosts.

### SUMMARY

Embodiments of the disclosure provide a storage controller that is configured to prevent monopolization of a resource by a specific host, and a storage device including the same.

According to an aspect of the disclosure, a storage device configured to communicate with a first host, a second host, and a supervisor, may include: a nonvolatile memory device that may include a first namespace allocated for the first host, a second namespace allocated for the second host, and a plurality of address mapping tables; and a storage controller configured to, based on the plurality of address mapping tables: access the first namespace based on an input/output request from the first host; and access the second namespace based on an input/output request from the second host. The storage controller may include a first dedicated caching area partitioned to cache address mapping tables having a first table type corresponding to the first namespace among the plurality of address mapping tables.

According to an aspect of the disclosure, a storage controller configured to control a nonvolatile memory device that may include a first namespace and a second namespace, the storage controller may include: a map data memory device that may include: a first dedicated caching area storing a first plurality of address mapping tables for the first namespace; and a second dedicated caching area storing a second plurality of address mapping tables for the second namespace; and a caching manager configured to manage a capacity of each of the first dedicated caching area and the second dedicated caching area.

According to an aspect of the disclosure, a storage device configured to communicate with a first host and a second host, may include: a nonvolatile memory device configured to store a global address mapping table that may include a first plurality of address mapping tables and a second plurality of address mapping tables respectively corresponding to the first host and the second host; and a storage controller that may include: a map data memory device configured to cache at least one of the first plurality of address mapping tables or the second plurality of address mapping tables; and a caching manager configured to manage a first occupation guarantee ratio of the first plurality of address mapping tables for the map data memory device.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram showing a storage system according to one or more embodiments of the present disclosure;

FIG. 2 is a block diagram showing a storage controller of FIG. 1 in more detail;

FIG. 3 is a drawing showing a method of caching an address mapping table in a map data memory device of FIG. 1;

FIG. 4 is a drawing showing a method of partitioning the map data memory device of FIG. 1;

FIG. 5 is a drawing showing a cache allocation table of FIG. 2 in more detail;

FIG. 6 is a drawing showing one of the address mapping tables of FIG. 3 in more detail;

FIG. 7 shows a method in which a storage device of FIG. 1 performs an input/output operation according to one or more embodiments;

FIG. 8 shows a method in which a storage device of FIG. 1 performs an input/output operation according to one or more embodiments;

FIG. 9 shows a method in which a storage device of FIG. 1 performs an input/output operation according to one or more embodiments;

FIG. 10 is a flowchart showing an operation of the storage controller of FIG. 1 that performs the input/output operation;

FIG. 11 is a flowchart showing an operation S140 of FIG. 10 in more detail;

FIG. 12 is a flowchart showing an operation S143 of FIG. 11 in more detail;

FIG. 13 shows an operation of the storage device according to a request of a supervisor of FIG. 1 according to one or more embodiments;

FIG. 14 shows an operation of the storage device according to a request of a supervisor of FIG. 1 according to one or more embodiments;

FIG. 15 is a drawing showing a method of updating the cache allocation table according to the embodiment of FIG. 14 in more detail;

FIG. 16 is a flowchart showing an operation of the storage controller that operates in response to an allocation ratio configuration request of FIG. 14;

FIG. 17 is a flowchart showing an operation S230 of FIG. 16 in more detail;

FIG. 18 is a flowchart showing an operation S232 of FIG. 17 in more detail; and

FIG. 19 is a drawing showing an operation of the storage system of FIG. 1 according to one or more embodiments.

### DETAILED DESCRIPTION

Below, embodiments of the present disclosure will be described clearly and in detail to such an extent that a person of an ordinary skill in the technical field of the present disclosure may easily perform the present disclosure. Details such as detailed configurations and structures are provided simply to facilitate an overall understanding of the embodiments of the present disclosure. Therefore, modifications of the embodiments described in the present disclosure may be performed by a person of an ordinary skill in the art without departing from the technical spirit and scope of the present disclosure. Moreover, descriptions of well-known functions and structures are omitted for clarity and brevity. Configurations in the drawings or a detailed description of the present disclosure may be connected to an element other than that shown in the drawings or described in the detailed description. Terms used in the present disclosure are defined considering functions of the present disclosure, and are not limited to specific functions. The definition of the terms may be determined based on details described in the detailed description.

Elements described with reference to a term such as a driver, a block, or the like used in the detailed description may be implemented in the form of software, hardware, or a combination thereof. For example, the software may be a machine code, firmware, an embedded code, and application software. For example, the hardware may include an electrical circuit, an electronic circuit, a processor, a computer, integrated circuit cores, a pressure sensor, an inertial sensor, a microelectromechanical System (MEMS), a passive element, or a combination thereof.

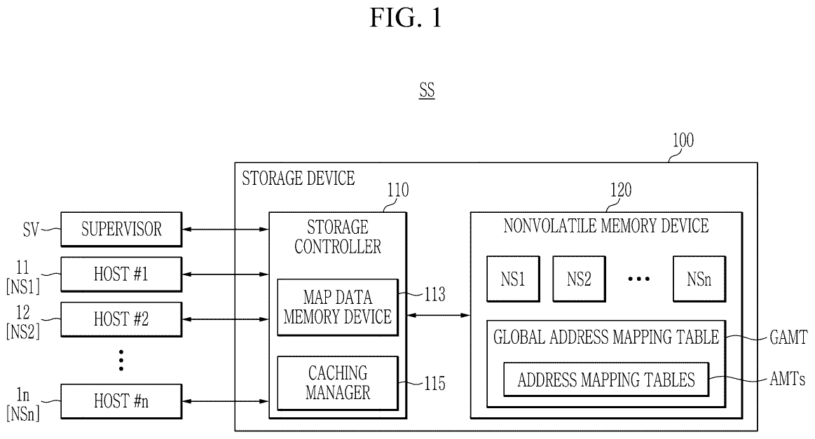

FIG. 1 is a block diagram showing a storage system according to one or more embodiments of the present disclosure. Referring to FIG. 1, the storage system SS may include a supervisor SV, first to n-th hosts 11-1n, and a storage device 100. In one or more embodiments, the storage system SS may be included in one of various information processing devices such as a personal computer, a laptop computer, a server, a workstation, a smartphone, a tablet PC, and the like.

Each of the supervisor SV and the first to n-th hosts 11-1n may access the storage device 100. In one or more embodiments, each of the supervisor SV and the first to n-th hosts 11-1n may be single or multi-core processors included in each of different computing nodes. Alternatively, at least some of the supervisor SV and the first to n-th hosts 11-1n may be different processors included in the same computing node. However, the scope of the present disclosure is not limited thereto, and each of the supervisor SV and the first to n-th hosts 11-1n may be a processor configured to process a different application, or a different virtual machine driven in a computing system.

The storage device 100 may include a storage controller 110 and a nonvolatile memory device 120.

The storage device 100 may be configured to support multi-host or multi-tenant. In other words, the storage controller 110 may operate in response to control of a plurality of hosts. For example, the storage controller 110 may store data in the nonvolatile memory device 120 or may read data from the nonvolatile memory device 120 based on requests issued from the first to n-th hosts 11-1n.

The storage device 100 may allocate a different storage space for each of the plurality of hosts. For example, the nonvolatile memory device 120 may include first to n-th namespaces NS1-NSn. The storage controller 110 may allocate the first to n-th namespaces NS1-NSn to the first to n-th hosts 11-1n, respectively.

The storage device 100 may allocate a different namespace identifier (NSID) for each of the first to n-th namespaces NS1-NSn. For example, namespace identifiers ‘1’ to ‘n’ may be allocated to the first to n-th namespaces NS1-NSn, respectively.

Each of the first to n-th hosts 11-1n may access only the namespace allocated by the storage device 100. For example, the first host 11 may access the first namespace NS1 by providing the namespace identifier ‘1’ to the storage controller 110, and the second host 12 may access the second namespace NS2 by providing the namespace identifier ‘2’ to the storage controller 110. However, the scope of the present disclosure is not limited thereto.

In one or more embodiments, the storage device 100 may communicate with the supervisor SV and the first to n-th hosts 11-1n based on a peripheral component interconnect express (PCIe) interface or a PCIe-based nonvolatile memory express (NVMe) interface.

The storage controller 110 may include a map data memory device 113 and a caching manager 115.

The first to n-th hosts 11-1n may access the storage device 100 based on logical address. On the other hand, the storage device 100 may perform a read operation and a program operation on the nonvolatile memory device 120 based on physical address. Accordingly, the storage controller 110 may distinguish and manage the logical address and the physical address. For example, the map data memory device 113 may store a plurality of address mapping tables indicating mapping information between the logical addresses and the physical addresses. The storage controller 110 may perform an address mapping operation based on the plurality of address mapping tables stored in the map data memory device 113. In other words, the storage controller 110 may perform an input/output operation for each of the first to n-th hosts 11-1n based on the plurality of address mapping tables stored in the map data memory device 113.

The storage device 100 may be an hyper-large capacity solid state drive (SSD). For example, the storage device 100 may be the hyper-large capacity SSD with a capacity of 64 TB or more. However, the scope of the present disclosure is not limited to a capacity of the storage device 100.

A capacity of address mapping tables managed by the storage controller 110 may be determined according to the capacity of the storage device 100. For example, the storage controller 110 included in the storage device 100 having a relatively large capacity may need to manage mapping information for relatively large number of physical addresses. Therefore, the storage controller 110 included in the storage device 100 having the relatively large capacity may need to manage address mapping tables having a relatively large capacity. Particularly, if the storage device 100 is the hyper-large capacity SSD, the storage controller 110 will need to manage address mapping tables having an hyper-large capacity. However, a capacity of the map data memory device 113 included in the storage controller 110 may be insufficient to store the address mapping tables having the hyper-large capacity. For example, in terms of a design of the storage device 100 and a cost of the storage device 100, it may be difficult to apply the map data memory device 113 having an infinitely large capacity.

Accordingly, the storage controller 110 may operate by caching the plurality of address mapping tables in the map data memory device 113. Hereinafter, one or more embodiments in which the plurality of address mapping table are cached in the map data memory device 113 will be representatively described.

The nonvolatile memory device 120 may include a global address mapping table GAMT. The global address mapping table GAMT may include a plurality of address mapping tables AMT used in the storage device 100.

In one or more embodiments, the global address mapping table GAMT may include all address mapping tables AMT used in the storage device 100. However, the scope of the present disclosure is not limited thereto.

The caching manager 115 may cache some of the plurality of address mapping tables AMT stored in the global address mapping table GAMT to the map data memory device 113. For example, the caching manager 115 may read the address mapping table AMT from the nonvolatile memory device 120, and may store the address mapping table AMT in the map data memory device 113. In this case, the storage controller 110 may perform an address mapping operation based on the address mapping table AMT cached in the map data memory device 113. That is, in response to input/output requests issued from the first to n-th hosts 11-1n, the storage controller 110 may perform an input/output operation based on the address mapping table AMT cached in the map data memory device 113.

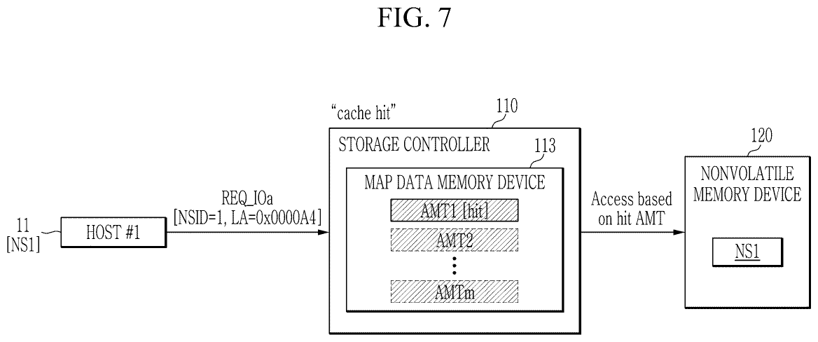

The input/output operation of the storage device 100 based on the address mapping table AMT cached in the map data memory device 113 will be described in more detail with reference to FIGS. 7 to 12 below.

The caching manager 115 may manage an occupation guarantee ratio for the map data memory device 113 for each table type of the address mapping tables AMT. For example, the caching manager 115 may allocate some areas of the map data memory device 113 for caching the address mapping tables AMT that are used for an input/output operation for the first namespace NS1 (e.g., used for an input/output operation of the first host 11), or may allocate another areas of the map data memory device 113 for caching the address mapping tables AMT that are used for an input/output operation for the second namespace NS2 (e.g., an input/output operation of the second host 12). In this way, the caching manager 115 may allocate different area of the map data memory device 113 for each table type of the address mapping tables AMT. In this case, even if random access input/output requests issued by some hosts with great frequency (e.g., even when some hosts are noisy-neighbors), the address mapping table AMT used for the input/output operations of the hosts may not monopolize the entire map data memory device 113. In other words, even if random access input/output requests occur at a great frequency by some hosts, some areas of the map data memory device 113 may store the address mapping table AMT used for an input/output operation of another host (e.g., the host that performs an input/output operation with a relatively low frequency but requires relatively high quality of service (QOS)). In this case, a phenomenon in which some hosts excessively occupy the map data memory device 113 (e.g., a monopoly or cache drain phenomenon) may be prevented, so that QoS for other hosts may be guaranteed. Thus, an overall operating performance of the storage system SS may be improved.

In one or more embodiments, size of an area of the map data memory device 113 allocated by the caching manager 115 for each table type of the address mapping tables AMT may be determined based on quality of service (QOS) required by each of the first to n-th hosts 11 to 1n.

In one or more embodiments, the supervisor SV may request information on a ratio of the map data memory device 113 allocated for each table type of the address mapping tables AMT to the storage device 100.

In one or more embodiments, the supervisor SV may request the storage device 100 to change a capacity of each area of the map data memory device 113 managed by the caching manager 115 based on QoS required by each of the first to n-th hosts 11-1n.

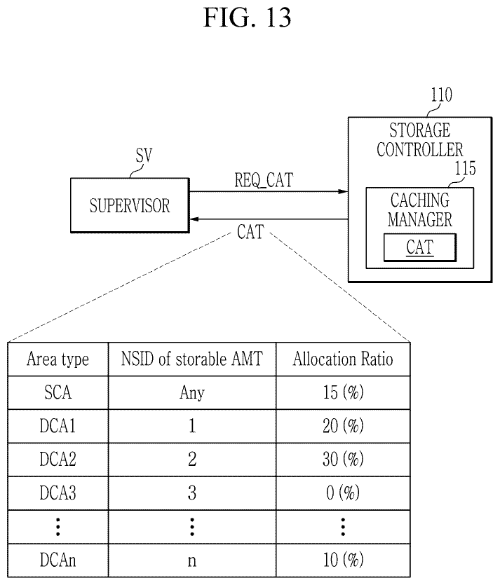

An operation of the storage device 100 according to request of the supervisor SV will be described in more detail with reference to FIGS. 13 to 19 below.

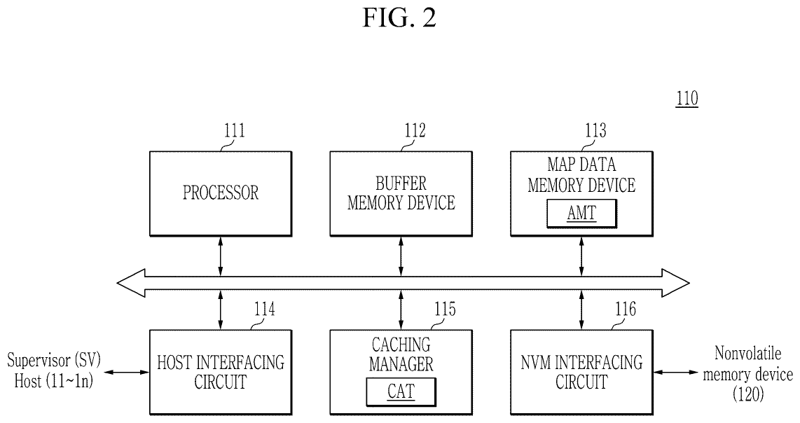

FIG. 2 is a block diagram showing the storage controller of FIG. 1 in more detail. Referring to FIG. 1 and FIG. 2, the storage controller 110 may include a processor 111, a buffer memory device 112, a map data memory device 113, a host interfacing circuit 114, a caching manager 115, and a nonvolatile memory interfacing circuit 116. The processor 111, the buffer memory device 112, the map data memory device 113, the host interfacing circuit 114, the caching manager 115, and the nonvolatile memory interfacing circuit 116 may be connected to each other through a bus.

The processor 111 may control an overall operation of the storage controller 110. For example, the processor 111 may execute various types of programs, applications, and firmware executed in the storage controller 110.

The buffer memory device 112 may be used as a buffer memory or an operation memory of the storage controller 110. For example, the buffer memory device 112 may be implemented as a static random access memory (SRAM), a dynamic random access memory (DRAM), or the like.

The map data memory device 113 may cache a plurality of address mapping tables AMT. For example, the map data memory device 113 may store some of the plurality of address mapping tables AMT included in the global address mapping table GAMT. In this case, the storage controller 110 may perform an address mapping operation based on the address mapping table AMT cached in the map data memory device 113.

In one or more embodiments, the map data memory device 113 may be implemented as a volatile memory device such as a dynamic random access memory (DRAM) or the like.

In one or more embodiments, the buffer memory device 112 and the map data memory device 113 may be implemented as a single volatile memory device. However, the scope of the present disclosure is not limited thereto. For example, the buffer memory device 112 and the map data memory device 113 may be implemented as a different volatile memory device.

The storage controller 110 may communicate with the supervisor SV and the first to n-th hosts 11-1n through the host interfacing circuit 114. For example, the host interfacing circuit 114 may communicate with the supervisor SV and the first to n-th hosts 11-1n based on at least one of various host interfaces such as a Peripheral Component Interconnect express (PCIe) interface, a nonvolatile memory express (NVMe) interface, a Serial ATA (SATA) interface, a Serial Attached SCSI (SAS) interface, a universal flash storage (UFS) interface, and the like. For a more concise description, hereinafter, it is assumed that the host interfacing circuit 114 communicates with the supervisor SV and the first to n-th hosts 11-1n based on the PCIe interface.

The caching manager 115 may control caching for the plurality of address mapping tables AMT. For example, if input/output requests for any logical addresses are provided by the first to n-th hosts 11-1n, but the address mapping table AMT indicating the physical addresses corresponding to the logical addresses is not cached in the map data memory device 113, the caching manager 115 may read an address mapping table AMT indicating the physical addresses corresponding to the logical addresses from the nonvolatile memory device 120. Thereafter, the caching manager 115 may perform an input/output operation by caching the read address mapping table AMT in the map data memory device 113. An operation of the caching manager 115 in response to the input/output requests from the first to n-th hosts 11-1n will be described in more detail with reference to FIGS. 7 to 12 below.

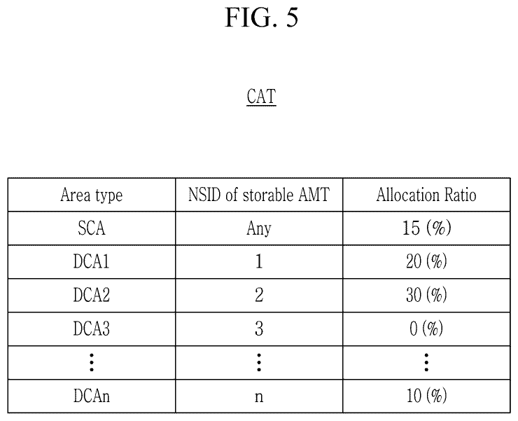

The caching manager 115 may control caching of the plurality of address mapping tables AMT based on QoS required by each of the first to n-th hosts 11-1n. For example, the caching manager 115 may include a cache allocation table CAT. The caching manager 115 may manage an occupation guarantee ratio for the map data memory device 113 of each of the first to n-th hosts 11-1n based on the cache allocation table CAT. A more detailed configuration of the cache allocation table CAT will be described in more detail with reference to FIG. 5 below.

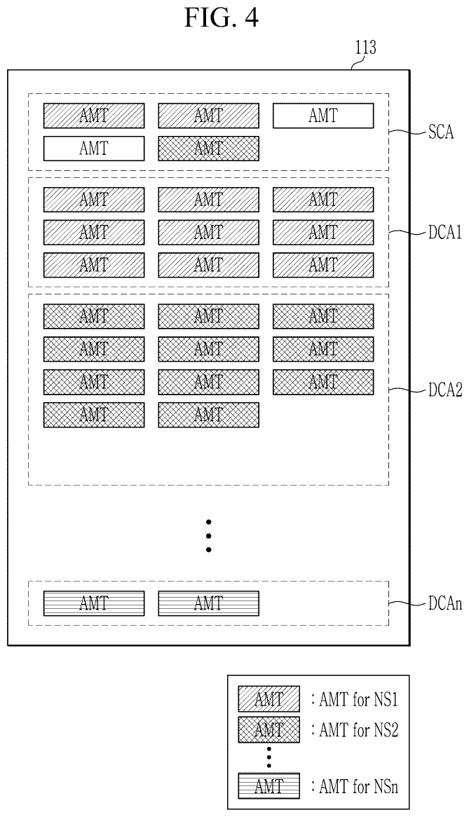

The caching manager 115 may manage the map data memory device 113 by partitioning the map data memory device 113 into a plurality of caching areas having different types based on the cache allocation table CAT. For example, the caching manager 115 may partition the map data memory device 113 into a plurality of dedicated caching areas and one shared caching area. A method in which the caching manager 115 partitions the map data memory device 113 based on the cache allocation table CAT will be described in more detail with reference to FIG. 4 below.

In one or more embodiments, the caching manager 115 may be implemented by hardware, software, or a combination of hardware and software. For example, at least a portion of the caching manager 115 may be included in the storage controller 110 in a form of a separate circuit, a separate device, or a separate chip. In addition, at least a portion of the caching manager 115 may be implemented as a firmware or software module executed by the processor 111. That is, for a more concise description, the caching manager 115 is shown as a separate component in FIG. 2, but some or all of the caching manager 115 may be included in one or more of the other components.

The storage controller 110 may communicate with the nonvolatile memory device 120 through the nonvolatile memory interfacing circuit 116. For example, the nonvolatile memory interfacing circuit 116 may communicate with the nonvolatile memory device 120 based on a NAND interface.

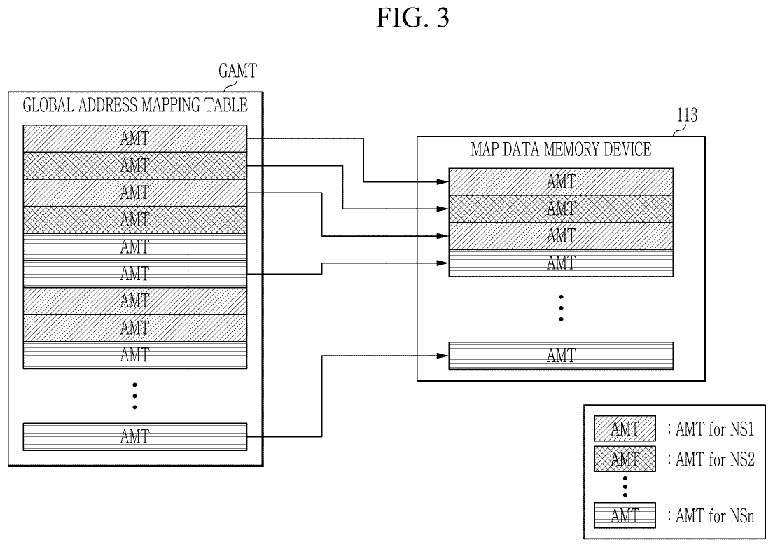

FIG. 3 is a drawing showing a method of caching the address mapping table in the map data memory device of FIG. 1. Referring to FIGS. 1 to 3, the global address mapping table GAMT may include the plurality of address mapping tables AMT used in the storage device 100. For example, the plurality of address mapping tables AMT included in the global address mapping table GAMT may represent mapping information for all pages included in the first to n-th namespaces NS1-NSn.

In one or more embodiments, a capacity of one address mapping table AMT may be equal to a capacity of one page included in the nonvolatile memory device 120. For example, the capacity of one address mapping table AMT may be about 4 KB. However, the scope of the present disclosure is not limited thereto.

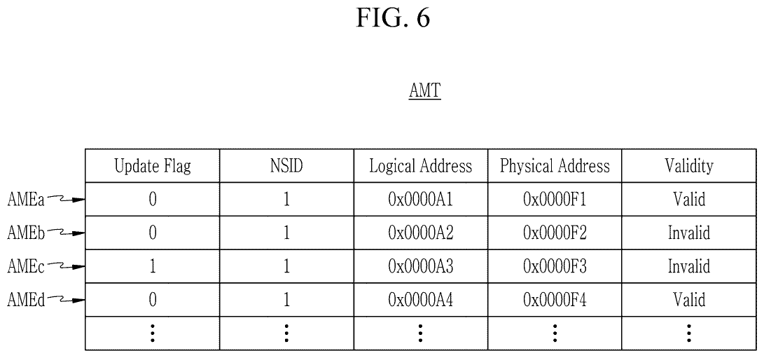

In one or more embodiments, each of a plurality of address mapping tables AMT may represent mapping information for one namespace. In other words, each of the plurality of address mapping tables AMT may represent mapping information for an input/output operation of one host. For example, each of the plurality of address mapping tables AMT may include a plurality of address mapping entries for one namespace. For a more detailed example, the address mapping table AMT shown as a diagonal stripe may represent mapping information for a plurality of pages included in the first namespace NS1; the address mapping table AMT shown as a grid may represent mapping information for a plurality of pages included in the second namespace NS2; and the address mapping table AMT shown as a horizontal stripe may represent mapping information for a plurality of pages included in the n-th namespace NSn. That is, hereinafter, it is assumed that one address mapping table AMT represents mapping information for a plurality of pages included in one namespace. A more detailed configuration of one address mapping table AMT will be described in more detail with reference to FIG. 6 below.

The map data memory device 113 may cache some of the plurality of address mapping tables AMT included in the global address mapping table GAMT. For example, the map data memory device 113 may cache some of the plurality of address mapping tables AMT included in the global address mapping table GAMT, so that the storage controller 110 performs an input/output operation in response to input/output commands from the first to n-th hosts 11-1n.

In one or more embodiments, a capacity of the map data memory device 113 may be less than a total capacity of the address mapping tables AMT included in the global address mapping table GAMT. In other words, the map data memory device 113 may not store the entire global address mapping table GAMT.

FIG. 4 is a drawing showing a method of partitioning the map data memory device of FIG. 1. Referring to FIGS. 1 to 4, the caching manager 115 may partition the map data memory device 113 into a plurality of caching areas having different types based on the cache allocation table CAT. For example, the caching manager 115 may divide the map data memory device 113 into first to n-th dedicated caching areas DCA1-DCAn and a shared caching area SCA.

Each of the first to n-th dedicated caching areas DCA1-DCAn may cache the plurality of address mapping tables AMT with one table type. For example, the first dedicated caching area DCA1 may exclusively cache the plurality of address mapping tables AMT with a first table type (i.e., address mapping tables shown as a diagonal stripe). In other words, address mapping tables for performing an input/output operation for a namespace other than the first namespace NS1 may not be cached in the first dedicated caching area DCA1. In a similar manner, the second to n-th dedicated caching areas DCA2-DCAn may exclusively cache address mapping tables for performing input/output operations for the second to n-th namespaces NS2-NSn, respectively.

Capacities of the first to n-th dedicated caching areas DCA1-DCAn may be different from each other. For example, the number of address mapping tables that may be stored in the second dedicated caching area DCA2 may be greater than the number of address mapping tables that may be stored in the first dedicated caching area DCA1. However, the scope of the present disclosure is not limited thereto.

In one or more embodiments, capacities of some of the first to n-th dedicated caching areas DCA1-DCAn may be ‘0’. In other words, the caching manager 115 may set an occupation guarantee ratio for the map data memory device 113 of some hosts to ‘0’. For example, the caching manager 115 may set a capacity of the third dedicated caching area DCA3 to ‘0’. However, the scope of the present disclosure is not limited thereto.

In one or more embodiments, the first to n-th dedicated caching areas DCA1-DCAn may be used to guarantee QoS of the first to n-th hosts 11-1n, respectively. For example, even if an input/output request from the first host 11 occurs at a high frequency, the address mapping table AMT used for an input/output operation of the first host 11 may not be stored in the second dedicated caching area DCA2. Accordingly, the address mapping table AMT used for an input/output request of the second host 12 may be sufficiently stored in the second dedicated caching area DCA2. In this case, when the input/output request from the second host 12 occurs, a possibility in which the address mapping table for performing the input/output operation is cached in the map data memory device 113 (i.e., a possibility of cache-hit occurrence) may increase.

The shared caching area SCA may cache the plurality of address mapping tables AMT regardless of a table type. For example, some of the address mapping tables AMT cached in the shared caching area may be address mapping tables AMT for the first namespace NS1; and others are may be the address mapping tables AMT for the second namespace NS2. In other words, table types of the address mapping tables AMT cached in the shared caching area SCA may be the same or different. That is, the shared caching area SCA may cache the address mapping table for any namespaces.

In one or more embodiments, if the first dedicated caching area DCA1 is in a full-state (e.g., if the first dedicated caching area DCA1 is in a state in which the no more address mapping table may be stored), the caching manager 115 may cache the address mapping table having a first table type (i.e., the address mapping table for the first namespace NS1) in the shared caching area SCA. Similarly, if the second dedicated caching area DCA2 is in a full-state, the caching manager 115 may cache the address mapping table having a second table type (i.e., the address mapping table for the second namespace NS2) in the shared caching area SCA.

FIG. 5 is a drawing showing the cache allocation table of FIG. 2 in more detail. Referring to FIGS. 1 to 5, the caching manager 115 may store the cache allocation table CAT. The caching manager 115 may manage capacities of the first to n-th dedicated caching areas DCA1-DCAn and the shared caching area SCA based on the cache allocation table CAT. For example, the caching manager 115 may determine a capacity allocation ratio of the map data memory device 113 for each of the first to n-th dedicated caching areas DCA1-DCAn and the shared caching area SCA based on the cache allocation table CAT.

In one or more embodiments, the capacity allocation ratio of the map data memory device 113 for the dedicated caching area DCA may also be referred to as an occupation guarantee ratio for the map data memory device 113 of the address mapping table for the namespace corresponding to the dedicated caching area DCA. For example, the capacity allocation ratio of the map data memory device 113 for the first dedicated caching area DCA1 may also be referred to as an occupation guarantee ratio for the map data memory device 113 of the address mapping tables for the first namespace NS1. However, the scope of the present disclosure is not limited to the term.

The cache allocation table CAT may represent a table type of the address mapping table AMT that may be stored in each of the first to n-th dedicated caching areas DCA1-DCAn and the shared caching area SCA. For example, the cache allocation table CAT may represent a namespace identifier (NSID) corresponding to the address mapping table that may be stored in each of the first to n-th dedicated caching areas DCA1-DCAn and the shared caching area SCA. For a more detailed example, the cache allocation table CAT may represent that the address mapping table corresponding to any NSID may be stored in the shared caching area SCA; and the address mapping table corresponding to the namespace identifier ‘1’ (i.e., the address mapping table for the first namespace NS1) may be stored in the first dedicated caching area DCA1. Similarly, the cache allocation table CAT may represent an address mapping table type (e.g., the namespace identifier for the namespace) that may be stored in each of the second to n-th dedicated caching areas DCA2-DCAn.

The cache allocation table CAT may represent a capacity ratio of the map data memory device 113 allocated to each of the first to n-th dedicated caching areas DCA1-DCAn and the shared caching area SCA. For example, the cache allocation table CAT may represent that a capacity of the shared caching area SCA is 15% of a capacity of the map data memory device 113; and a capacity of the first dedicated caching area DCA1 is 20% of the capacity of the map data memory device 113. Similarly, the cache allocation table CAT may represent a capacity of each of the second to n-th dedicated caching areas DCA2-DCAn.

In one or more embodiments, the caching manager 115 may manage a sum of capacity ratios of the map data memory device 113 allocated to each of the first to n-th dedicated caching areas DCA1-DCAn and the shared caching area SCA as 100%. For example, if the capacity of the first dedicated caching area DCA1 is increased, the caching manager 115 may reduce the capacity of the shared caching area SCA. Conversely, if the capacity of the first dedicated caching area DCA1 is reduced, the caching manager 115 may increase the capacity of the shared caching area SCA. However, the scope of the present disclosure is not limited thereto.

FIG. 6 is a drawing showing one of the address mapping tables of FIG. 3 in more detail. Referring to FIGS. 1 to 6, the address mapping table AMT may include a plurality of address mapping entries AME. For example, the address mapping table AMT may include first to fourth address mapping entries AMEa-AMEd.

One address mapping table AMT may correspond to one address mapping table type. That is, one address mapping table AMT may correspond to one namespace (or one namespace identifier). For example, each of the plurality of address mapping entries AME included in one address mapping table AMT may represent mapping information for the same namespace. For a more detailed example, the first to fourth address mapping entries AMEa-AMEd may represent mapping information for different pages included in the first namespace NS1.

Each of the plurality of address mapping entries AME may represent the namespace identifier, the logical address, the physical address mapped to the namespace identifier and the logical address, and validity of the mapping. For example, the first address mapping entry AMEa may represent that a mapping between the logical address ‘0x0000A1’ and the physical address ‘0x0000F1’ within the first namespace NS1 is valid. Similarly, the second address mapping entry AMEb may represent that a mapping between the logical address ‘0x0000A2’ and the physical address ‘0x0000F2’ within the first namespace NS1 is invalid. In this way, the plurality of address mapping entries AME included in a single address mapping table AMT may represent different mapping information for the same namespace.

In one or more embodiments, each of the plurality of address mapping entries AME may include an update flag bit. The update flag bit of each of the plurality of address mapping entries AME may indicate whether the address mapping entry AME cached in the map data memory device 113 is changed after a time point when the address mapping table AMT is cached in the map data memory device 113 from the global address mapping table GAMT. For example, if the third address mapping entry AMEc is changed (e.g., if a physical address or a validity of the third address mapping entry AMEc is changed), the caching manager 115 may change the update flag bit of the third address mapping entry AMEc to 1.

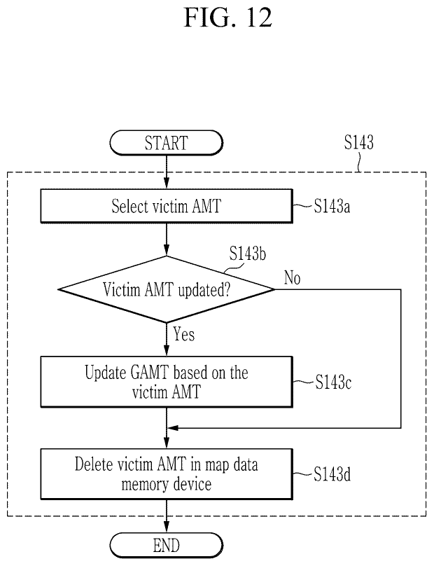

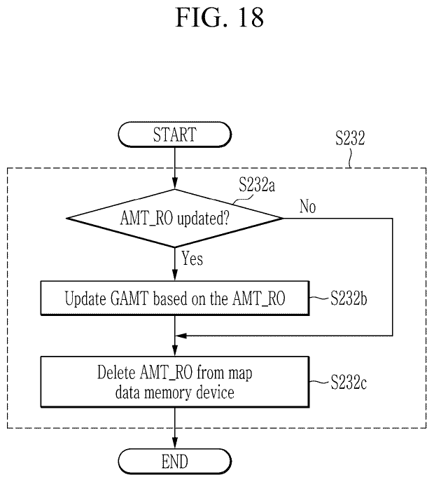

In one or more embodiments, if the address mapping table AMT including the address mapping entry AME in which the update flag bit is set to ‘1’ is deleted (i.e., de-cached) from the map data memory device 113, the caching manager 115 may update an address mapping table, which is corresponding to the de-cached address mapping table, among the plurality of address mapping tables AMT stored in the global address mapping table GAMT. An operation of the caching manager 115 based on the update flag bit will be described in more detail with reference to FIG. 12 and FIG. 18 below.

FIGS. 7 to 9 are drawings showing a method in which the storage device of FIG. 1 performs an input/output operation according to one or more embodiments. Hereinafter, an operation of the storage device 100 operating in response to an input/output request REQ_IO from the first host 11 will be representatively described with reference to FIGS. 1 to 9. However, the scope of the present disclosure is not limited thereto, and the storage device 100 may operate in a similar manner for the second to n-th hosts 12-1n.

First, referring to FIGS. 1 to 7, the first host 11 may access the first namespace NS1 by transmitting a first input/output request REQ_IOa to the storage controller 110. In this case, the first input/output request REQ_IOa may include the namespace identifier ‘1’ and the logical address ‘0x0000A4’.

A first address mapping table AMT1 corresponding to the first input/output request REQ_IOa may be cached in the map data memory device 113. In this case, the storage controller 110 may identify the first address mapping table AMT1 based on the namespace identifier and the logical address included in the first input/output request REQ_IOa. For example, the storage controller 110 may identify the first address mapping table AMT1 that includes the address mapping entry AME corresponding to the namespace identifier ‘1’ and the logical address ‘0x0000A4’ within the map data memory device 113. In other words, cache hit for the first input/output request REQ_IOa may occur.

In one or more embodiments, if the address mapping table AMT corresponding to the first input/output request REQ_IOa is cached in the map data memory device 113, the address mapping table AMT may be referred to as a ‘hit address mapping table’. For example, first address mapping table AMT1 may be referred to as a hit address mapping table.

The storage controller 110 may access the nonvolatile memory device 120 based on the hit address mapping table. For example, if the first address mapping table AMT1 is the address mapping table AMT described with reference to FIG. 5, the storage controller 110 may identify the physical address ‘0x0000F4’ corresponding to the namespace identifier ‘1’ and the logical address ‘0x0000A4’ based on the fourth address mapping entry AMEd. In this case, the storage controller 110 may perform an input/output operation for the physical address ‘0x0000F4’. In other words, the storage controller 110 may program data provided from the first host 11 at the physical address ‘0x0000F4’, or may read data stored at the physical address ‘0x0000F4’.

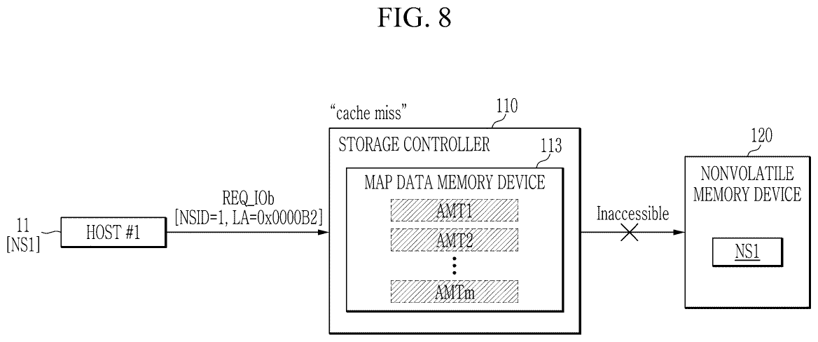

On the other hand, referring to FIG. 8, the first host 11 may access the first namespace NS1 by transmitting a second input/output request REQ_IOb to the storage controller 110. In this case, the second input/output request REQ_IOb may include the namespace identifier ‘1’ and the logical address ‘0x0000B2’.

However, unlike the description described above with reference to FIG. 7, the address mapping table AMT corresponding to the second input/output request REQ_IOb may not be cached in the map data memory device 113. For example, the address mapping table AMT including the address mapping entry AME corresponding to the namespace identifier ‘1’ and the logical address ‘0x0000B2’ may not be cached in the map data memory device 113. In other words, cache-miss for the second input/output request REQ_IOb may occur. In this case, the storage controller 110 may not access the nonvolatile memory device 120.

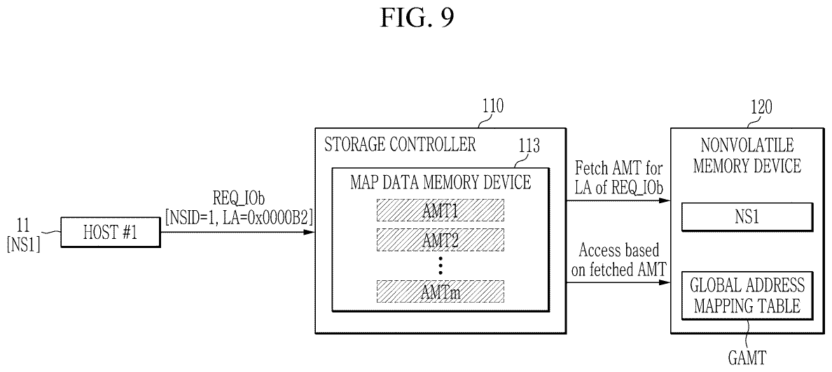

Next, referring to FIG. 9, the storage controller 110 may fetch the address mapping table AMT for the second input/output request REQ_IOb from the nonvolatile memory device 120. For example, the caching manager 115 may read the address mapping table AMT including the address mapping entry AME corresponding to the namespace identifier ‘1’ and the logical address ‘0x0000B2’ included in the second input/output request REQ_IOb from the global address mapping table GAMT. Thereafter, the caching manager 115 may store the read address mapping table AMT in the map data memory device 113. In this case, the storage controller 110 may perform an input/output operation for the second input/output request REQ_IOb based on the address mapping table AMT for the second input/output request REQ_IOb stored in the map data memory device 113. For example, storage controller 110 may perform input/output operations for the physical address corresponding to the namespace identifier ‘1’ and the logical address ‘0x0000B2’. For example, the storage controller 110 may perform an input/output operation on a physical address corresponding to the namespace identifier ‘1’ and the logical address ‘0x0000B2’.

In one or more embodiments, the caching manager 115 may store the address mapping table AMT read from the global address mapping table GAMT in the dedicated caching area DCA or the shared caching area SCA. For example, if the address mapping table AMT read from the global address mapping table GAMT corresponds to the first namespace NS1, the caching manager 115 may store the address mapping table AMT in the first dedicated caching area DCA1 or the shared caching area SCA.

In one or more embodiments, if the first dedicated caching area DCA1 is not in a full-state, the caching manager 115 may store the address mapping table AMT read from the global address mapping table GAMT in the first dedicated caching area DCA1.

In one or more embodiments, if the first dedicated caching area DCA1 is not in the full-state and the shared caching area SCA is not in a full-state, the caching manager 115 may store the address mapping table AMT read from the global address mapping table GAMT in the shared caching area SCA.

In one or more embodiments, when both the first dedicated caching area DCA1 and the shared caching area SCA are in the full-state, the caching manager 115 may delete one of the address mapping tables AMT stored in the first dedicated caching area DCA1, and then may store the address mapping table AMT read from the global address mapping table GAMT in the first dedicated caching area DCA1.

In one or more embodiments, the caching manager 115 may select and delete one of the plurality of address mapping tables AMT stored in the first dedicated caching area DCA1 based on a least recently use (LRU) algorithm. However, the scope of the present disclosure is not limited to a specific algorithm in which the caching manager 115 selects the address mapping table AMT to be deleted.

In one or more embodiments, the address mapping table AMT stored in the first dedicated caching area DCA1 that the caching manager 115 deletes may include the address mapping entry AME having the update flag bit ‘1’. In this case, the caching manager 115 may store the address mapping table AMT in the nonvolatile memory device 120 before deleting the address mapping table AMT from the map data memory device 113.

That is, according to the embodiment of the present disclosure, if the address mapping table AMT corresponding to the input/output request provided from the host is cached in the map data memory device 113 (i.e., if a cache hit occurs), the storage controller 110 may immediately perform an input/output operation based on the cached address mapping table AMT. On the other hand, if the address mapping table AMT corresponding to the input/output request provided from the host is not cached in the map data memory device 113 (i.e., if a cache miss occurs), the storage controller 110 may perform an input/output operation after reading the address mapping table AMT from the global address mapping table GAMT. In this case, a time required to perform the input/output operation after the input/output request is received from the host when the cache miss occurs may be longer than that of when the cache hit occurs.

In one or more embodiments, as the number of the address mapping tables AMT used for an input/output operation of a specific host that are cached within the map data memory device 113 increases, a probability of a cache hit occurring when an input/output request from the host occurs may increase. For example, as the number of the address mapping tables AMT used for an input/output operation of the first host 11 (i.e., the address mapping tables AMT for the first namespace NS1) that are cached increases, a probability in which the storage device 100 will operate in the manner described above with reference to FIG. 7 in response to an input/output request from the first host 11 may increase. In this case, a time required for the storage device 100 to perform an input/output operation in response to the input/output request from the first host 11 may be reduced.

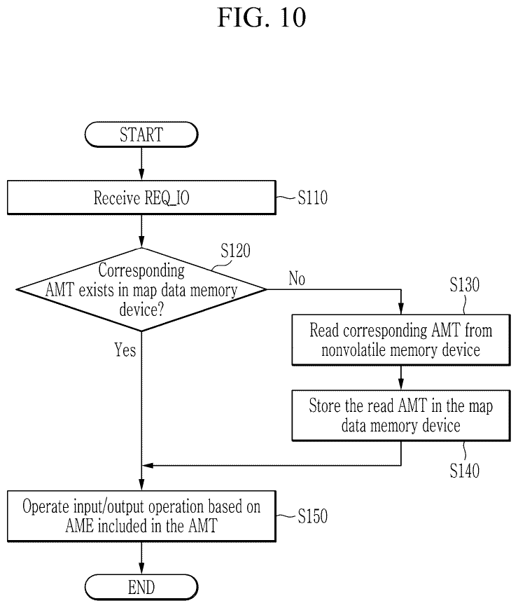

FIG. 10 is a flowchart showing an operation of the storage controller of FIG. 1 that performs the input/output operation. Referring to FIGS. 1 to 10, in an operation S110, the storage controller 110 may receive the input/output request REQ_IO. For example, the storage controller 110 may receive the input/output request REQ_IO from one of the first to n-th hosts 11-1n through the host interfacing circuit 114. In this case, the input/output request REQ_IO may include the namespace identifier and the logical address.

In an operation S120, the storage controller 110 may determine whether the address mapping table AMT corresponding to the input/output request REQ_IO exists within the map data memory device 113. For example, the caching manager 115 may determine whether the address mapping table AMT including the address mapping entry AME corresponding to the namespace identifier and the logical address included in the input/output request REQ_IO previously received in the operation S110 is cached in the map data memory device 113.

If it is determined that the address mapping table AMT corresponding to the input/output request REQ_IO exists in the map data memory device 113, the following operation S150 may be performed. If it is determined that the address mapping table AMT corresponding to the input/output request REQ_IO does not exist in the map data memory device 113, the following operations S130 to S140 may be performed.

In the operation S130, the storage controller 110 may read the address mapping table AMT corresponding to the input/output request REQ_IO from the nonvolatile memory device 120. For example, the caching manager 115 may read the address mapping table AMT including the address mapping entry AME corresponding to the namespace identifier and the logical address included in the input/output request REQ_IO from the global address mapping table GAMT.

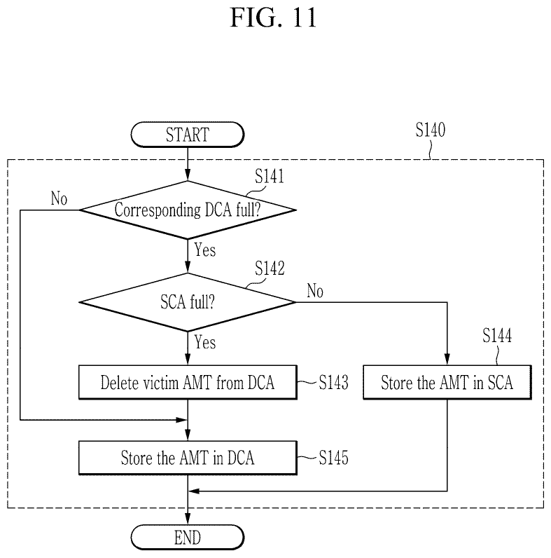

In the operation S140, the storage controller 110 may store the read address mapping table AMT in the map data memory device 113. For example, the caching manager 115 may store the address mapping table AMT previously read through the operation S130 in the map data memory device 113. The operation S140 will be described in more detail with reference to FIG. 11 and FIG. 12 below.

In the operation S150, the storage controller 110 may perform an input/output operation based on the address mapping entry AME included in the address mapping table AMT. For example, the storage controller 110 may identify a physical address corresponding to the namespace identifier and the logical address included in the input/output request REQ_IO provided in the operation S110, based on the address mapping entry AME included in the address mapping table AMT. Thereafter, the storage controller 110 may perform an input/output operation on the identified physical address.

FIG. 11 is a flowchart showing the operation S140 of FIG. 10 in more detail. Referring to FIGS. 1 to 11, the operation S140 may include the following operations S141 to S145.

In the operation S141, the storage controller 110 may determine whether the corresponding dedicated caching area DCA is in a full-state. For example, the caching manager 115 may determine whether the dedicated caching area DCA for the namespace corresponding to the input/output request REQ_IO of the operation S110 (i.e., the namespace corresponding to the address mapping table AMT read in the operation S130) is in the full-state. For a more detailed example, if the namespace identifier ‘1’ for the first namespace NS1 is included in the input/output request REQ_IO of the operation S110 described above (i.e., if the address mapping table AMT read in the operation S130 described above corresponds to the first namespace NS1), the caching manager 115 may determine whether more of the address mapping table AMT can be stored in the first dedicated caching area DCA1.

If it is determined that the dedicated caching area DCA is in the full-state, the following operation S142 may be performed, and if it is determined that the dedicated caching area DCA is not in the full-state, the following operation S143 may be performed.

In the operation S142, the storage controller 110 may determine whether the shared caching area SCA is in a full-state. For example, the caching manager 115 may determine whether more of the address mapping table AMT can be stored in the shared caching area SCA.

If the shared caching area SCA is determined to be in the full-state, the following operation S143 may be performed, and if the shared caching area SCA is determined to be not in the full-state, the following operation S144 may be performed.

In the operation S143, the storage controller 110 may delete a victim address mapping table from the dedicated caching area DCA. For example, if the address mapping table AMT read in the operation S130 described above corresponds to the first namespace NS1, the caching manager 115 may delete the victim address mapping table included in the first dedicated caching area DCA1. After this, the first dedicated caching area DCA1 may not be in the full-state.

In one or more embodiments, the address mapping table AMT that is deleted from the map data memory device 113 may be referred to as ‘victim address mapping table’.

In the operation S144, the storage controller 110 may store the address mapping table AMT in the shared caching area SCA. For example, the caching manager 115 may store the address mapping table AMT previously read through the operation S130 in the shared caching area SCA.

In the operation S145, the storage controller 110 may store the address mapping table AMT in the dedicated caching area DCA. For example, if the address mapping table AMT read in the operation S130 described above corresponds to the first namespace NS1, the caching manager 115 may store the address mapping table AMT previously read through the operation S130 in the first dedicated caching area DCA1.

FIG. 12 is a flowchart showing the operation S143 of FIG. 11 in more detail. Referring to FIGS. 1 to 12, the operation S143 may include operations S143a to S143d.

In the operation S143a, the caching manager 115 may select the victim address mapping table. For example, the caching manager 115 may select one of the plurality of address mapping tables AMT stored in the first dedicated caching area DCA1 as the victim address mapping table.

In one or more embodiments, the caching manager 115 may select the victim address mapping table based on the LRU algorithm. For example, the caching manager 115 may select the address mapping table AMT used for the input/output operation the longest ago as the victim address mapping table. However, the scope of the present disclosure is not limited to a specific manner in which the caching manager 115 selects the victim address mapping table.

In the operation S143b, the caching manager 115 may determine whether the victim address mapping table is updated. For example, the caching manager 115 may determine whether one or more update flag bits among the plurality of address mapping entries AME included in the victim address mapping table are set to ‘1’.

If it is determined that the victim address mapping table is updated, the following operation S143c may be performed, and if it is determined that the victim address mapping table is not updated, the following operation S143d may be performed.

In the operation S143c, the caching manager 115 may update the global address mapping table GAMT based on the victim address mapping table. For example, the caching manager 115 may update one address mapping table AMT corresponding to the victim address mapping table among the plurality of address mapping tables AMT included in the global address mapping table GAMT based on the victim address mapping table. In this case, the global address mapping table GAMT may be synchronized with the victim address mapping table before the victim address mapping table is deleted.

In the operation S143d, the caching manager 115 may delete the victim address mapping table from the dedicated caching area DCA. For example, the caching manager 115 may delete the victim address mapping table included in the first dedicated caching area DCA1.

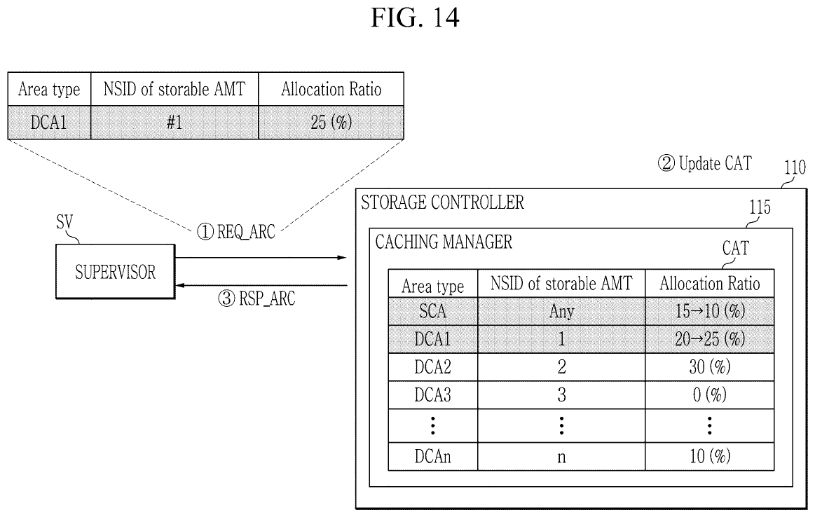

FIG. 13 and FIG. 14 are drawings showing an operation of the storage device according to a request of the supervisor of FIG. 1 according to one or more embodiments.

First, referring to FIGS. 1 to 6 and 13, the supervisor SV may transmit a cache allocation table request REQ_CAT to the storage controller 110. In this case, the storage controller 110 may transmit the cache allocation table CAT managed by the caching manager 115 to the supervisor SV in response to the cache allocation table request REQ_CAT.

The supervisor SV may identify a capacity ratio of the map data memory device 113 allocated to each of the shared caching area SCA and the first to n-th dedicated caching areas DCA1-DCAn based on the cache allocation table CAT.

In one or more embodiments, the supervisor SV may adjust the capacity ratio of the map data memory device 113 allocated to each of the shared caching area SCA and the first to n-th dedicated caching areas DCA1-DCAn based on QoS required by each of the first to n-th hosts 11-1n. A method in which the supervisor SV adjusts the capacity ratio of the map data memory device 113 allocated to each of the shared caching area SCA and the first to n-th dedicated caching areas DCA1-DCAn will be described in more detail with reference to FIG. 14 below.

Next, referring to FIGS. 1 to 6 and 14, the supervisor SV may transmit an allocation ratio configuration request REQ_ARC to the storage controller 110. For example, the supervisor SV may request to adjust the capacity ratio of the map data memory device 113 allocated to the first dedicated caching area DCA1 through the allocation ratio configuration request REQ_ARC. For a more detailed example, the supervisor SV may request to adjust the capacity ratio of the map data memory device 113 allocated to the first dedicated caching area DCA1 to 25% through the allocation ratio configuration request REQ_ARC.

The storage controller 110 may update the cache allocation table CAT in response to the allocation ratio configuration request REQ_ARC. For example, the caching manager 115 may change the capacity ratio of map data memory device 113 allocated for the first dedicated caching area DCA1 from 20% to 25%.

The caching manager 115 may reduce the capacity ratio of the map data memory device 113 allocated to the shared caching area SCA by the capacity ratio of the map data memory device 113 additionally allocated to the first dedicated caching area DCA1. For example, the caching manager 115 may change the capacity ratio of the map data memory device 113 allocated for the shared caching area SCA from 15% to 10%.

In one or more embodiments, if the storage controller 110 succeeds in updating the cache allocation table CAT in response to the allocation ratio configuration request REQ_ARC, the storage controller 110 may back up the updated cache allocation table CAT in the nonvolatile memory device 120. In this case, even if the storage device 100 is powered off, the storage controller 110 may restore the cache allocation table CAT. However, the scope of the present disclosure is not limited thereto.

In one or more embodiments, the storage controller 110 may fail to update the cache allocation table CAT according to the allocation ratio configuration request REQ_ARC. For example, a minimum limit (e.g., 10%) of the capacity ratio of the map data memory device 113 allocated for the shared caching area SCA may be predetermined. In this case, as the capacity ratio of the map data memory device 113 allocated to the first dedicated caching area DCA1 is increased according to the allocation ratio configuration request REQ_ARC, if the capacity ratio of the map data memory device 113 allocated to the shared caching area SCA decreases to less than a predetermined minimum limit, the storage controller 110 may not update the cache allocation table CAT.

The storage controller 110 may transmit an allocation ratio configuration response RSP_ARC corresponding to the allocation ratio configuration request REQ_ARC to notify the supervisor SV of whether the cache allocation table CAT is updated based on the allocation ratio configuration request REQ_ARC. For example, the storage controller 110 may transmit the allocation ratio configuration response RSP_ARC indicating a success of the update of the cache allocation table CAT to the supervisor SV, or may transmit the allocation ratio configuration response RSP_ARC indicating a failure of the update of the cache allocation table CAT to the supervisor SV.

In one or more embodiments, if the storage controller 110 transmits the allocation ratio configuration response RSP_ARC indicating that the update of the cache allocation table CAT fails to the supervisor SV, the storage controller 110 may notify the supervisor SV of a reason why the update of the cache allocation table CAT fails. For example, the storage controller 110 may notify that the allocation ratio configuration request REQ_ARC requests an excessively large allocation ratio.

In one or more embodiments, the supervisor SV may read the cache allocation table CAT from the storage controller 110 in the manner described above with reference to FIG. 13 in response to the allocation ratio configuration response RSP_ARC indicating that the update of the cache allocation table CAT fails. In this case, the supervisor SV may retransmit the allocation ratio configuration request REQ_ARC to the storage controller 110 based on the read cache allocation table CAT.

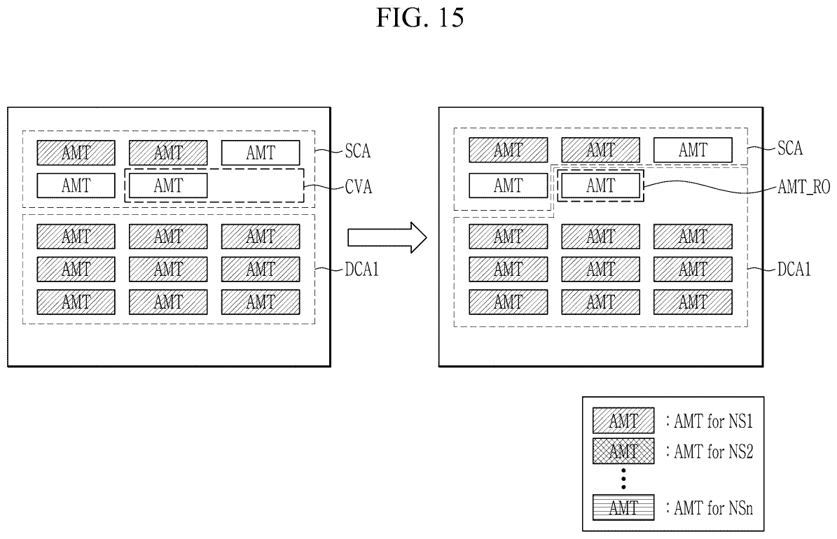

FIG. 15 is a drawing showing a method of updating the cache allocation table according to the embodiment of FIG. 14 in more detail. Referring to FIGS. 1 to 6 and 14 to 15, the caching manager 115 may update the cache allocation table CAT in response to the allocation ratio configuration request REQ_ARC. For example, the caching manager 115 may increase the capacity ratio of the map data memory device 113 allocated to the first dedicated caching area DCA1, and may reduce the capacity ratio of the map data memory device 113 allocated to the shared caching area SCA. In other words, the caching manager 115 may switch a conversion area CVA that is a portion of the shared caching area SCA as a portion of the first dedicated caching area DCA1. That is, the caching manager 115 may change the conversion area CVA from the shared caching area SCA to the first dedicated caching area DCA1 in response to the allocation ratio configuration request REQ_ARC.

In one or more embodiments, the address mapping table AMT included in the conversion area CVA may correspond to a namespace different from that of the first dedicated caching area DCA1. For example, the address mapping table AMT included in the conversion area CVA may be an address mapping table for a third namespace NS3 rather than the address mapping table for the first namespace NS1. In this case, only the address mapping table for the first namespace NS1 may be stored in the first dedicated caching area DCA1, so that the address mapping table AMT included in the conversion area CVA may not be stored in the first dedicated caching area DCA1.

Hereinafter, for a more concise description, the address mapping table that may not be stored in the dedicated caching area DCA expanded in response to the allocation ratio configuration request REQ_ARC (i.e., the address mapping table corresponding to another namespace) among address mapping tables included in the conversion area CVA may be referred to as a range over address mapping table AMT_RO.

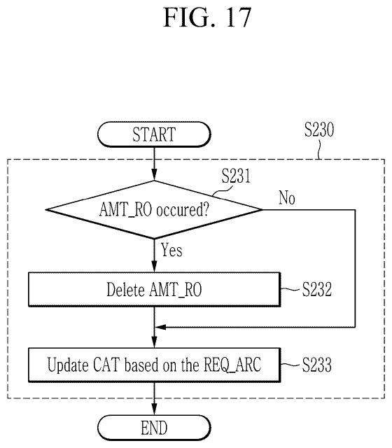

In one or more embodiments, the range over address mapping table AMT_RO may need to be deleted from the conversion area CVA prior to updating the cache allocation table CAT. For example, a method of deleting the range over address mapping table AMT_RO will be described in more detail with reference to FIG. 17 and FIG. 18 below.

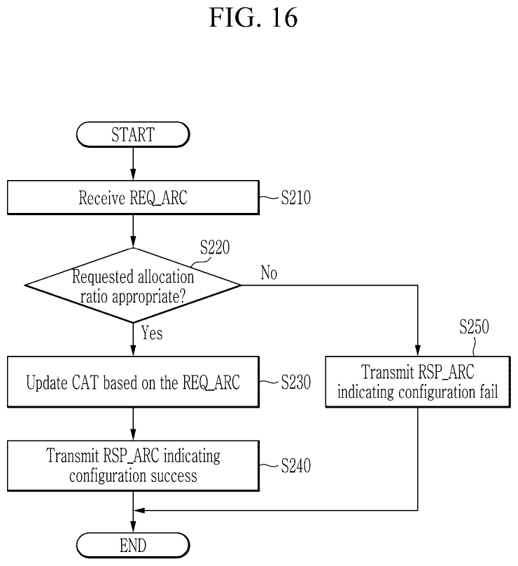

FIG. 16 is a flowchart showing an operation of the storage controller that operates in response to the allocation ratio configuration request of FIG. 14. Referring to FIGS. 1 to 6 and 14 to 16, in an operation S210, the storage controller 110 may receive the allocation ratio configuration request REQ_ARC from the supervisor SV.

In an operation S220, the storage controller 110 may determine whether the requested allocation ratio is appropriate. For example, if the capacity ratio of the map data memory device 113 allocated to the shared caching area SCA decreases to less than a predetermined minimum limit as the capacity ratio of the map data memory device 113 allocated to the first dedicated caching area DCA1 is increased in response to the allocation ratio configuration request REQ_ARC, the caching manager 115 may determine that the requested allocation ratio is inappropriate (i.e., excessive).

If the requested allocation ratio is determined to be appropriate, the following operations S230 and S240 may be performed. If the requested allocation ratio is determined to be inappropriate, the following operation S250 may be performed.

In the operation S230, the storage controller 110 may update the cache allocation table CAT in response to the allocation ratio configuration request REQ_ARC. For example, the caching manager 115 may change the capacity ratio of the map data memory device 113 allocated to the dedicated caching area DCA and the shared caching area SCA in response to the allocation ratio configuration request REQ_ARC.

In the operation S240, the storage controller 110 may transmit the allocation ratio configuration response RSP_ARC indicating that the configuration is successful in response to the allocation ratio configuration request REQ_ARC to the supervisor SV.

In the operation S250, the storage controller 110 may transmit the allocation ratio configuration response RSP_ARC indicating that the configuration fails in response to the allocation ratio configuration request REQ_ARC to the supervisor SV.

FIG. 17 is a flowchart showing the operation S230 of FIG. 16 in more detail. Referring to FIGS. 1 to 6 and 14 to 17, the operation S230 may include the following operations S231 to S233.

In the operation S231, the caching manager 115 may determine whether the range over address mapping table AMT_RO occurs. For example, the caching manager 115 may identify the address mapping table that may not be stored in the dedicated caching area DCA expanded in response to the allocation ratio configuration request REQ_ARC (i.e., the address mapping table corresponding to another namespace) among address mapping tables included in the conversion area CVA determined based on the allocation ratio configuration request REQ_ARC.

If it is determined that the range over address mapping table AMT_RO occurs, the following operation S232 may be performed, and if it is determined that the range over address mapping table AMT_RO does not occur, the following operation S233 may be performed.

In the operation S232, the caching manager 115 may delete the range over address mapping table AMT_RO. For example, the caching manager 115 may delete the range over address mapping table AMT_RO from the map data memory device 113.

In the operation S233, the caching manager 115 may update the cache allocation table CAT in response to the allocation ratio configuration request REQ_ARC. For example, the caching manager 115 may change the capacity ratio of the map data memory device 113 allocated to the dedicated caching area DCA and the shared caching area SCA in response to the allocation ratio configuration request REQ_ARC.

FIG. 18 is a flowchart showing the operation S232 of FIG. 17 in more detail. Referring to FIGS. 1 to 6 and 14 to 18, the operation S232 may include the following operations S232a to S232c.

In the operation S232a, the caching manager 115 may determine whether the range over address mapping table AMT_RO is updated. For example, the caching manager 115 may determine whether one or more update flag bit among the plurality of address mapping entries AME included in the range over address mapping table AMT_RO are set to ‘1’.

If it is determined that the range over address mapping table AMT_RO is updated, the following operation S232b may be performed, and if it is determined that the range over address mapping table AMT_RO is not updated, the following operation S232c may be performed.

In the operation S232b, the caching manager 115 may update the global address mapping table GAMT based on the range over address mapping table AMT_RO. For example, the caching manager 115 may update one address mapping table AMT corresponding to the range over address mapping table AMT_RO among the plurality of address mapping tables AMT included in the global address mapping table GAMT based on the range over address mapping table AMT_RO. In this case, the global address mapping table GAMT may be synchronized with the range over address mapping table AMT_RO before the range over address mapping table AMT_RO is deleted.

In the operation S232c, the caching manager 115 may delete the range over address mapping table AMT_RO from the map data memory device 113. For example, the caching manager 115 may delete the range over address mapping table AMT_RO from the conversion area CVA.

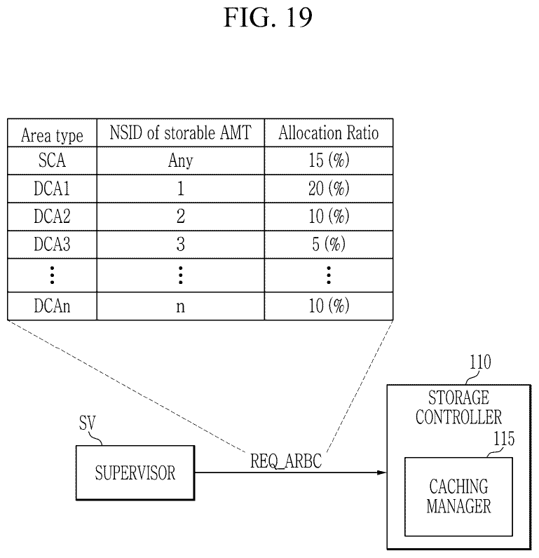

FIG. 19 is a drawing showing an operation of the storage system of FIG. 1 according to one or more embodiments. Referring to FIGS. 1 to 19, the supervisor SV may collectively set the allocation ratio of the map data memory device 113 for each of the shared caching area SCA and the first to n-th dedicated caching areas DCA1-DCAn. For example, the supervisor SV may transmit an allocation ratio batch configuration request REQ_ARBC to the storage controller 110.

The storage controller 110 may update the cache allocation table CAT in response to the allocation ratio batch configuration request REQ_ARBC. For a more concise description, the embodiment in which the supervisor SV collectively sets the allocation ratio of the map data memory device 113 for each of the shared caching area SCA and the first to n-th dedicated caching areas DCA1-DCAn is representatively described in FIG. 19, but the scope of the present disclosure is not limited thereto. For example, the supervisor SV may issue the allocation ratio batch configuration request REQ_ARBC to collectively set the allocation ratio of the map data memory device 113 for two or more of the shared caching area SCA and the first to n-th dedicated caching areas DCA1-DCAn.

While the disclosure has been particularly shown and described with reference to embodiments thereof, it will be understood that various changes in form and details may be made therein without departing from the spirit and scope of the following claims.

What is claimed is:

1. A storage device configured to communicate with a first host, a second host, and a supervisor, the storage device comprising:
a nonvolatile memory device comprising a first namespace allocated for the first host, a second namespace allocated for the second host, and a plurality of address mapping tables; and
a storage controller configured to, based on the plurality of address mapping tables:
access the first namespace based on an input/output request from the first host; and
access the second namespace based on an input/output request from the second host,
wherein the storage controller comprises a first dedicated caching area partitioned to cache address mapping tables having a first table type corresponding to the first namespace among the plurality of address mapping tables.

2. The storage device of claim 1, wherein the storage controller further comprises a shared caching area partitioned to cache a one or more address mapping tables having different table type from each other, from among the plurality of address mapping tables.

3. The storage device of claim 2, wherein a capacity of the first dedicated caching area is determined based on a first allocation ratio configuration request provided by the supervisor.

4. The storage device of claim 3, wherein a capacity of the shared caching area is determined based on the capacity of the first dedicated caching area.

5. The storage device of claim 2, wherein the storage controller is further configured to:
perform a first input/output operation for the nonvolatile memory device based on a first address mapping entry for a first logical address, which is cached in the first dedicated caching area or the shared caching area, based on a first input/output request being provided from the first host and comprising the first logical address.

6. The storage device of claim 5, wherein the storage controller is further configured to:
read a first address mapping table comprising the first address mapping entry from the nonvolatile memory device, and store the first address mapping table in the storage controller, based on the first address mapping entry not being in the first dedicated caching area and the shared caching area.

7. The storage device of claim 6, wherein the storage controller is further configured to:
store the first address mapping table in the first dedicated caching area based on the first dedicated caching area not being full;
store the first address mapping table in the shared caching area, based on the first dedicated caching area being full and the shared caching area not being full; and
store the first address mapping table in the first dedicated caching area after deleting a second address mapping table in the first dedicated caching area, based on the first dedicated caching area and the shared caching area being full.

8. The storage device of claim 7, wherein the storage controller is further configured to:
update the second address mapping table in the nonvolatile memory device, based on the second address mapping table being updated after a first time point when the second address mapping table is cached in the first dedicated caching area.

9. The storage device of claim 1, wherein a capacity of each of the plurality of address mapping tables is same as a capacity of a unit page of the nonvolatile memory device.

10. A storage controller configured to control a nonvolatile memory device comprising a first namespace and a second namespace, the storage controller comprising:
a map data memory device comprising:
a first dedicated caching area storing a first plurality of address mapping tables for the first namespace; and
a second dedicated caching area storing a second plurality of address mapping tables for the second namespace; and
a caching manager configured to manage a capacity of each of the first dedicated caching area and the second dedicated caching area.

11. The storage controller of claim 10, wherein:
a first address mapping table among the first plurality of address mapping tables comprises a first plurality of address mapping entries that map physical addresses and logical addresses for a first plurality of pages in the first namespace; and
a second address mapping table among the second plurality of address mapping tables comprises a second plurality of address mapping entries that map physical addresses and logical addresses for a second plurality of pages in the second namespace.

12. The storage controller of claim 10, wherein the map data memory device further comprises:
a shared caching area configured to store a third plurality of address mapping tables for the first namespace and a fourth plurality of address mapping tables for the second namespace.

13. The storage controller of claim 12, wherein:
a third address mapping table of the third plurality of address mapping tables comprises a third plurality of address mapping entries that map physical addresses and logical addresses for a third plurality of pages in the first namespace; and
a fourth address mapping table among the fourth plurality of address mapping tables comprises a fourth plurality of address mapping entries that map physical addresses and logical addresses for a fourth plurality of pages in the second namespace.

14. The storage controller of claim 12, wherein the caching manager is further configured to convert a first conversion area, that is a portion of the shared caching area, to the first dedicated caching area, based on a first allocation ratio configuration request from an external device.

15. The storage controller of claim 14, wherein the caching manager is further configured to store a range over address mapping table, which is in the first conversion area and corresponds to the second namespace in the nonvolatile memory device.

16. The storage controller of claim 12, wherein the caching manager is further configured to perform a first input/output operation on the nonvolatile memory device based on a first address mapping entry for a first logical address which is stored in the map data memory device, based on a first input/output request comprising the first logical address for the first namespace provided by an external device.

17. The storage controller of claim 16, wherein the caching manager is further configured to:
read a fifth address mapping table comprising the first address mapping entry from the nonvolatile memory device and store the fifth address mapping table in the map data memory device, based on the first address mapping entry not being in the first plurality of address mapping tables and the third plurality of address mapping tables.

18. The storage controller of claim 17, wherein the caching manager is configured to:
store the fifth address mapping table in the first dedicated caching area, based on the first dedicated caching area not being full;
store the fifth address mapping table in the shared caching area, based on the first dedicated caching area being full and the shared caching area not being full; and
store the fifth address mapping table in the first dedicated caching area after deleting a sixth address mapping table that is one of the first plurality of address mapping tables, based on the first dedicated caching area and the shared caching area being full.

19. A storage device configured to communicate with a first host and a second host, the storage device comprising:
a nonvolatile memory device configured to store a global address mapping table comprising a first plurality of address mapping tables and a second plurality of address mapping tables respectively corresponding to the first host and the second host; and
a storage controller comprising:
a map data memory device configured to cache at least one of the first plurality of address mapping tables or the second plurality of address mapping tables; and
a caching manager configured to manage a first occupation guarantee ratio of the first plurality of address mapping tables for the map data memory device.

20. The storage device of claim 19, wherein:
the map data memory device comprises a first dedicated caching area corresponding to the first occupation guarantee ratio, and
the first dedicated caching area is configured to exclusively cache the first plurality of address mapping tables among the first plurality of address mapping tables and the second plurality of address mapping tables.
